(19) United States
(12) Patent Application Publication
(10) Pub. No.: US 2022/0156222 A1
(43) Pub. Date: May 19, 2022

(54) KEYBOARD, BUS UNIT, BUS CONTROL UNIT AND METHOD FOR OPERATING A KEYBOARD

(71) Applicant: Christoph HELDEIS, München (DE)

(72) Inventors: Christoph HELDEIS, München (DE); Tilo HACKE, Anzing (DE)

(73) Assignee: Christoph HELDEIS, München (DE)

(21) Appl. No.: 17/422,804

(22) PCT Filed: Jan. 15, 2019
(86) PCT No.: PCT/EP2019/050940

§ 371 Date: Jul. 14, 2021

(51) Int. Cl. G06F 13/42; G06F 3/02

(52) U.S. Cl. CPC G06F 13/4282; G06F 3/02

(57) ABSTRACT

An input arrangement, especially a keyboard, including: at least two bus wires of a bus, at least 10 or at least 100 bus units which are electrically connected to the bus wires and which respectively are electrically connected to at least one input element, wherein the bus units are electrically connected in parallel connection to the bus wires.

### FIELD OF THE INVENTION

This invention generally relates to keyboards and other input devices. The invention concerns more particularly possibilities for connecting the switches or integrated circuits that are connected to a switch with a computer device.

The input arrangement may be for instance:
a keyboard, especially an alpha numeric keyboard having at least 50 key switches, usually not more than 200 key switches or not more than 2000 key switches. The keyboard may be a device separate of a computer or it may be an integral part of the computer, or
a keypad having between 10 and 20 key switches, especially a keypad used for entrance control.

For instance, the keyboard may comprise of at least one, two, three, four, five or all of:
at least 25 keys for the input of letters a, b, c etc.,
at least 10 keys for the input of digits 0, 1, 2, etc., preferably combined with further input characters, for instance “!”, “§”, “$” etc.
at least 10 keys for functions, i.e. function F1, function F2, etc.,
at least 10 keys of a keypad for entering numbers, i.e. digits 0, 1, 2, etc., especially a further group of these numbers,
no further input characters are used for the keys of the further group,
modifier keys as for instance defined in the HID (Human Interface Device) specification, i.e. left CTRL, left SHIFT, left ALT, left GUI (Graphic User Interface), i.e. for instance Microsoft left Win key, Macintosh Left Apple key, Sun left Meta key etc., right CTRL, right SHIFT, right ALT, right GUI, —auxiliary keys: Caps Lock, Tab, Spacebar, Page Down, Page Up, Right Arrow, Left Arrow, Up Arrow, Down Arrow.

Alternatively the input arrangement may be a keypad, a game console, a game pad or a computer mouse that has a lot of buttons, for instance more than 10 buttons.

### BACKGROUND OF THE INVENTION

There are several principles for arranging the switches, for instance in a matrix form.

### SUMMARY OF THE INVENTION

An input arrangement may be used, especially a keyboard, comprising:
at least two bus wires or bus lines of a bus, and
at least 10 bus units (SLC) which are electrically connected to the bus wires and which respectively are electrically connected to at least one input element,

wherein the bus units are electrically connected in parallel connection to the bus wires.

Furthermore, there are corresponding units, i.e. bus unit and bus control unit, as well as corresponding methods according to the independent claims.

### DESCRIPTION OF GENERAL EMBODIMENTS

It is an object of the invention to give an improved input arrangement, especially an input arrangement that can be produced in an easy and cost effective way. Furthermore, a corresponding bus unit, bus control unit as well as corresponding method have to be given.

These problems are solved by the device according to claim 1, by the units according to the independent claims and by the method according to the independent method claims. Embodiments are given in the sub claims.

The input arrangement, especially a keyboard, may comprise:
at least two bus wires or bus lines of a bus,
at least 10 or at least 100 bus units (SLC) which are electrically connected to the bus wires and which respectively are electrically connected to at least one input element,
wherein the bus units are electrically connected in parallel connection to the bus wires.

The resulting input arrangement is simply in construction and can be produced in a cost effective way. A new construction principle for input devices is given. No matrix of sense lines and drive lines and no circuitry for driving the drive lines and for sensing of the sense lines have to be used any more. There are no problems with ghost keying if several key switches are pressed at the same time.

Even if one bus unit connected to a special input element, for instance to a key switch for a function key or key switch, e.g. F11 key, does not work properly, all other bus units for all other keys do work. This is a real advantage in comparison with a serial connection of the bus units.

Connection in parallel means that there are many taps that branch from the bus wires to respective bus units. The taps are preferably very short, for instance shorter than 5 cm (centimeters) or shorter than 1 cm.

The bus units may also be named as SLC (Slave Controller/subordinated controller). The bus units may transfer data with a bus control unit or MIC (Master Interface controller) that is explained in more detail below.

The input element may be a mechanical switch or an electrical push button or a touch button, for instance a pressure sensor or a touch sensor (capacitive or piezo electrical). The input elements may comprise only two terminals. A single pole single throw switch may be used, especially a push button switch or corresponding semiconductor device. Single pole single throw switches have a simpler construction compared to single pole double throw switches or push buttons. The input element may normally be open, i.e. if not activated or pressed down.

All bus units and the bus wires may be arranged on a common carrier, for instance on a printed circuit board (PCB).

There may be only 2 bus wires that are used for data communication. The two bus wires may also be used for the delivery of an operation voltage to each of the bus units. Alternatively there may be separate wires for the delivery of the operating voltage of the bus units.

The two bus wires may be used for a serial data communication which results in a keyboard having a simple construction. The bus may contain only two bus wires. Furthermore, it is possible to transmit data by robust differential signaling where two complementary signal are transmitted for each data bit on its own conductor or wire, for instance as a signal with a plus potential and a signal having a minus signal.

It is also possible to have more than two bus wires that are used for data communication, for instance at least 4, 8, 16 bus wires. Thus a fast parallel transmission of data is possible. In particular, there may be several pairs of bus wires each used for differential signaling that is robust with regard to EMI (Electro Magnetic Interference).

The bus units may comprise each:
a storage cell for storing an identifier, especially an address that identifies the respective bus unit with regard to the other bus units on the same bus wires in an unambiguous way,
a counter unit,
a comparison unit, and
a bus access unit that accesses the bus depending on an output signal of the comparison unit,
wherein all bus units preferably have the same internal structure.

The bus access unit may not access the bus if the comparison made by the comparison unit is negative. Thus the bus unit may be implemented completely within hardware in an easy way. The comparison unit may compare the value of the identifier or implicit address and the value of a counter that is part of the counter unit. This will be explained in more detail below with regard to the Figures.

An implicit address scheme may be used. No address lines have to be used within the bus system. This means that complexity is reduced. It is possible to address the bus units by using the counter and the comparison unit if the respective bus unit, i.e. all bus units, read the data that is transmitted via the bus wires. The bus unit may detect special data that requires it to increment or decrement the counter. The start of this kind of addressing may be signaled via the bus wires in advance, i.e. there may be also other data transfer modes.

All bus units may have a different identifier with regard to the other bus units on the same bus. It is possible to program the identifiers during the manufacturing of the input arrangement, i.e. during the mounting of the bus units on a carrier that carries the bus wires. The programming of the identifier may also be done after the manufacturing of the input arrangement by a special method, for instance it may be possible to send a signal via the bus and then to measure the transmission speed of the signal in each bus unit. Other ways for determining the identifiers are also possible. Non-volatile memory may be used, i.e. ROM (Read Only Memory), PROM (Programmable ROM), EPROM (Erasable PROM), EEPROM (Electrically EPROM), etc.

Alternatively it is possible to determine the addresses for each power on and to store these identifiers or addresses in volatile storage units, e.g. in RAM (Random Access Memory). There may be several methods that allow consecutive addressing of bus units along the bus. It is possible to detect the order of the parallel connected bus units and to give the bus units addresses according to this order. This means that bus units that are nearer to the beginning of the bus have lower numbers than bus units that are farther away. This may be true for all bus units. Thus it is possible to make the addressing in the same unambiguous and unique way each time, i.e. a special key of the keyboard will have always the same address.

However, if the bus system is changed in the meantime, i.e. between two consecutive power on events, there may be other results. It may be possible to add or remove bus units. Furthermore the bus system may be made longer or shorter. All these changes may be automatically considered within the next allocation of addresses. It has to be underlined that the proposed allocation scheme automatically adapts to different numbers of bus units on the bus system. This means that no changes have to be made with regard to the allocation method, preferably a hardware method, depending on customer demands, versions or subversions of the bus system.

During address allocation, special care may be taken to consider tolerances of the detection devices as well as the influences of interferences, for instance from EMI or instable power supplies. Compared to the speeds of data transmission on the bus system there may be much more time for address allocation using the chain of electronic components.

Addressing is possible by using a chain of resistors and/or capacitors having taps or branches that are connected to input and output pins of the bus units. The combination of the bus, the chain of electronic elements and of an input detection device as well as the possibility to output data at each element within the chain allows several schemes for giving or allocating addresses to the bus units.

The detection unit within each bus unit may be a Schmitt Trigger circuit that has lower complexity for instance with regard to an ADC (Analogue Digital Converter). However, if an ADC is used for other purposes multi use also for the allocation of the addresses is possible. Four methods for allocation will be mentioned at the end of the description, i.e. one method using a Schmitt Trigger and two methods using ADCs.

In electronics, a Schmitt trigger is a comparator circuit with hysteresis implemented by applying positive feedback to the non-inverting input of a comparator or differential amplifier. It is an active circuit which converts an analog input signal to a digital output signal. The circuit is named a “trigger” because the output retains its value until the input changes sufficiently to trigger a change. In the non-inverting configuration, when the input is higher than a chosen threshold, the output is high. When the input is below a different (lower) chosen threshold the output is low, and when the input is between the two levels the output retains its value. This dual threshold is the hysteresis.

The internal structure of the bus units may refer to the layout of integrated circuits or to the same functional units. Thus all bus units may have the same layout.

The bus units may comprise:
at least one LED, preferably at least 3 LEDs,
at least one storage cell for storing data that is used for driving or controlling of the at least one LED, preferably data that is used to control the brightness or to calibrate the brightness of the at least one LED,
and/or wherein each bus unit comprises an analog digital converter whose input is electrically connected with a potentiometer whereby the potentiometer is mechanically coupled with the input element.

There may be three LEDs (light emitting diode) in each bus unit, for instance a red one, a green one and a blue one (RGB). Thus it is possible to control the LEDs in such a way that the human eye sees not only these basic colors but also other colors, i.e. orange, yellow etc. The LEDs may be controlled by using PWM (Pulse Width Modulation) or another modulation scheme. It is further possible to use calibration data in the bus units that calibrate LEDs under consideration of so called bins, i.e. sorting the chips in such a way that all the LEDs from one particular bin give the same light color and have similar light output, i.e. brightness. It may be possible to write the LED data and/or to read the LED data via the bus wires.

If there is an ADC (analogue digital converter) and a potentiometer within the bus unit, it is possible to read how deep a key switch is pressed and to consider this in an application. Furthermore it is possible to suppress bouncing of the input signals. Alternatively other input converters than a potentiometer may be used.

The bus units may further comprise a state machine.

Additionally to the state machine or alternatively to the state machine a protocol for data transmission via the bus wires may be implemented in the bus units, preferably a bus protocol that uses a 8b/10b encoding and/or a 8b/10b decoding. Reference is made to “A DC-balanced, partitioned-block, 8B/10B transmission code”, A. X. Widmer, P. A. Franaszek, IBM J. Res. Develop., Volume 27, No. 5, September 1983, page 440 to page 451. The 8b/10b encoding and/or 8b/10b decoding that is described in the Widmer article may be modified if appropriate for implementing the invention or its embodiments.

The decoding and encoding may be done by a receiving unit and/or by a sending unit of the bus units. All internal buses and function units of the bus units may use tokens (having for instance a bit length of 8 bits) while only the external bus, e.g. DHIB, may use symbols (having for instance a bit length of 10 bits). It may be a key feature of the system that the state machine works with easier to handle unambiguous tokens. Each command/message may be represented by exactly one token, while many tokens may be represented by two or even four different symbols. The core task of the state machine of the bus units may be to execute commands and process messages, all of which are represented by tokens. Roughly spoken the state machine of the bus units may be the layer 2 engine with some layer 3 functions, while the receiving unit and/or the sending unit of the bus units are doing the logical part of layer1 according to the protocol stack that comprises for instance the seven layers that are defined by ITU (International Telecommunication Union). The state machine of a bus unit itself may be completely independent of the encoding and decoding. It may only get and deliver the tokens together with a few flags marking COMMA, commands and errors.

The state machine of the bus units may have several internal states. Depending on an external signal the states of the state machine of the bus units are changed and thereby outputs may be produced. It is possible to implement a state machine of the bus units completely as an electronic circuit, i.e. without using a processor that executes commands encoded in a software program. This allows cheap and fast circuits.

As mentioned above, reference is made to A. X. Widmer and P. A. Franaszek, “A DC-Balanced, Partitioned-Block, 8B/10B Transmission Code”, IBM J. RES. DEVELOP., Vol. 27, No. 5th September 1983, pp. 440 to 451, and to the literature listed at the end of this article with regard to 8B/10B codes. They propose to use partitioning of the coder into 5B/6B and 3B/4B subordinate coders. However input arrangements may be used that implement coding without partitioning.

Eight bits of data may be encoded in a symbol having ten bits. Thereby redundancy for error detection and possibly error correction is added. Furthermore much care is taken for balancing the ones and zeros in a symbol thus enabling differential signaling. Differential signaling is very robust with regard to EMI (Electromagnetic Interference), i.e. it can be used for long transmission lines or for lines that are interfered by electromagnetic waves. This may be important for industrial applications.

It is of course possible to use other coding schemes as well or to adapt the 8B/10B code or code symbols with regard to the application in input arrangements, especially in keyboards.

At least one bus control unit may be electrically connected to the bus wires, wherein the bus control unit comprises:
a state machine,
and preferably an interface unit to an external processor unit, especially an SPI unit and or an input data memory, preferably an input FIFO, that is used for data transmission from the processor unit to the bus control unit,
and preferably an output data memory, especially an output FIFO, that is used for data transmission from bus control unit to the processor unit.

The bus control unit may be also named as MIC (Master interface controller). The proposed features allow an implementation that does not have to be laid open to costumers that use the bus control unit. The external processor, that may be a state of the art processor, does not have to care about the bus protocol. Bus commands and data coming from the external processor may be strictly divided from clock data and protocol specific data. This allows modifying of the bus protocol without notifying customers that buy the input arrangement or the bus control unit. Furthermore it is possible to send data to the MCU that does not include gaps with no data.

The state machine of the bus control unit may have several internal states. Depending on an external signal the states of the state machine of the bus control unit are changed and thereby outputs may be produced. It is possible to implement a state machine of the bus control unit(s) completely as an electronic circuit, i.e. without using a processor that executes commands encoded in a software program. This allows cheap and fast circuits. The state machine of the bus control unit itself may be completely independent of the encoding and decoding. It may only get and deliver the tokens together with a few flags marking COMMA, commands and errors.

The state machine of the bus control unit may also implement the interface to the processor that receives the data from the input arrangement. This processor may be a MCU (Microcontroller unit) that is connected directly to a main processor or that is electrically coupled to another MCU, for instance by USB (universal serial bus), Bluetooth or other transmission schemes for wired or wireless data transmission. The further MCU may change data with a main processor that executes an operating system, for instance Windows, iOS, Android etc.

A standard SPI (Serial Peripheral Interface) may be used. Alternatively other interfaces may be used, for instance interfaces for parallel data transmission.

It is possible to use two FIFO (first in first out) memories. The usage of a FIFO allows that the processor and the bus control unit transfer data in an easy way and preferably without gaps. Furthermore, the bus control unit may inspect several bytes of data within the FIFO for finding out what kind of command has to be executed next. It is preferred to arrange the data that is read from the bus units without gaps in the FIFO. Thus performance of data transfer is high. It is possible to use other memories for data transfer.

A bus protocol for data transmission via the bus wires (D+, D−) implemented in the bus control unit may comprise a decoding unit and/or an encoding unit, preferably an 8B/10B decoding and preferably an 8B/10 coding. The advantages of using this block coding are the same as the advantages that have been mentioned above for the complementary coding/decoding scheme in the bus units. Again, it is possible to use other coding schemes as well.

The decoding and encoding may be is done by a receiving unit and/or by a sending unit of the bus control unit(s). All internal buses and function units of the bus control unit may use tokens (having for instance a bit lengths of 8 bits) while only the external bus, e.g. DHIB, may use symbols (having for instance a bit length of 10 bits). It may be a key feature of the system that the state machine works with easier to handle unambiguous tokens. Each command/message may be represented by exactly one token, while many tokens may be represented by two or even four different symbols. The core task of the state machine of the bus control unit(s) may be to execute commands and process messages, all of which are represented by tokens. Roughly spoken the state machine of the bus control unit(s) may be the layer 2 engine with some layer 3 functions, while the receiving unit and/or the sending unit of the bus control unit(s) are doing the logical part of layer1 according to the protocol stack that comprises for instance the seven layers that are defined by ITU (International Telecommunication Union).

An advantage of the proposed coding scheme is the run length limitation RLL that allows a differential signaling and the fast transmission of commands. Furthermore, it is possible to implement these coding/decoding schemes completely in hardware resulting in a very fast bus system. Furthermore, the clock maybe generated from the data that are transmitted, i.e. no separate clock line is necessary. However, the bus control unit and the bus units may comprise internal clock generation units that allow them to synchronize to the clock that is implicitly included within the transmitted data signal.

The bus control unit may comprise:
a storage cell for storing an identifier, especially an address that identifies the respective bus control unit with regard to other bus control units on the same bus wires in an unambiguous way,
a counter unit,
a comparison unit, and
a bus access unit that accesses the bus depending on an output signal of the comparison unit,
wherein preferably at least two bus control units are electrically connected to the bus wires, the at least two bus control units having preferably the same internal structure.

The same access scheme that was mentioned above for the bus units may also be used within a MIC (Master interface controller) group, i.e. a group of bus control units. Each bus control unit may be used for an SLC (Slave Controller/subordinated controller) group, i.e. a group of bus units.

If there is more than one bus control unit, it is possible to use the interface to the external processor or MCU only in one of these bus control units. By using MICs for different functions depending on their location within the bus it is possible to have only one chip or ASIC design for the bus control units that are used on different places and with different functions on the bus wires.

The at least two bus control units may be connected to the bus wires in parallel or in serial connection.

Each bus unit may preferably comprise a receiver unit which receives data according to a differential signal transmitting method. By using differential transmitting schemes and/or electronic line termination it is possible to have more robustness with regard to noise, EMI, etc. even if the voltages are low, e.g. 5 Volt, 3.3 Volt or even lower than 3.3 Volt. Lower voltage results in lower power consumption.

A chain, i.e. a serial connection, of electronic elements may be used, for instance of resistors or capacitors or both of resistors and capacitors, especially with taps between the elements connected to an input of a respective bus unit. The technical effects of such a chain has already been described above, i.e. automatically address allocation.

A carrier device may be used that carries the bus wires and the bus units as well as optionally also the bus control unit. The carrier may comprises in at least 90 percent of volume a printed circuit board material, especially FR-4 (Fire Retardant) or a flexible material, or a plastic material or a metal.

The bus units and/or also the bus control unit may be implemented as electronic circuit, especially in ASICs (Application specific integrated circuits, i.e. a kind of hard wiring standard circuits according to customers demand), wherein the electronic circuit is preferably implemented as state machine, preferably as a state machine without a processor that executes commands of a program.

The ASICs (Application Specific Integrated Circuit) may be produced in a cost effective way and allow the fabrication of an integrated chip that is tailored to the specifications of a customer, for instance to the specifications of the producer of the input arrangement. If the demand is high enough it is of course possible to produce special integrated chips that do not use the ASIC technology any more.

Alternatively, it is also possible to use implementations that are more software related, i.e. by using simple microprocessors within the bus units and/or within the bus control units. However these solutions may be more complex and/or may have greater power consumption.

A bus unit (SLC) may comprise:
a storage cell for storing an identifier, especially an address, that identifies the respective bus unit with regard to the other bus units on the same bus wires of a bus in an unambiguous way,
a counter unit,
a comparison unit, and
a bus access unit that accesses the bus depending on an output signal of the comparison unit.

The same technical effects that have been mentioned above for the input arrangement/keyboard and for the bus unit thereof also apply for the bus unit and its embodiments if the bus unit is produced and sold separately from the input arrangement, i.e. as part for a bus system.

The bus unit (SLC) may comprise subunits of a bus unit in an input arrangement according to one of the embodiments mentioned above, preferably an 8b/10b encoding unit and/or an 8b/10b decoding unit. This means that the bus unit has subunits that are adapted to the bus system and/or to the bus protocol.

A bus control unit (MIC) may comprise:
a state machine,
an interface unit to an external processor unit, especially an SPI unit,
an input data memory, preferably an input FIFO, that is used for data transmission from the processor to the bus control unit,
and an output data memory, especially an output FIFO, that is used for data transmission from the bus control unit to the processor unit.

The same technical effects that have been mentioned above for the input arrangement/keyboard and for the bus control unit thereof also apply for the bus control unit and its embodiments if the bus control unit is produced and sold separately from the input arrangement, i.e. as part for a bus system.

The bus control unit (MIC) may further comprise subunits of a bus control unit according to one of the embodiments mentioned above. This means that the bus control unit has subunits that are adapted to the bus system and/or to the bus protocol.

A method for operating an input arrangement may comprise:
using at least two bus wires of a bus,
connecting a plurality of bus units in parallel connection to the bus wires,
using at least one bus control unit that receives data from the bus units depending on pressed input elements that are electrically connected to the bus units.

The same technical effects that have been mentioned above for the input arrangement/keyboard also apply for the method and its embodiments. This means that the method relates to the operation of a bus system that comprises bus wires/connection lines, bus units connected to the bus wires as well as at least one bus control unit. The bus protocol may use 8b/10b (b stands for bit) coding/decoding and/or may be based on differential data transmission, especially using serial data transmission.

The method results in a simple input arrangement for performing the method. The method implements a new principle for operating input arrangements and keyboards, i.e. no matrix of input elements is needed. There are no problems with ghost keying etc. any more. Even if one bus unit is defect, all other bus units can be used because of the parallel connection to the bus.

The method may further comprise:
allocation of internal identifiers to bus units,
at least during block read or block write operations all bus units or at least two bus units read data on the bus wires,
at least during block read or block write operations all bus units or at least two bus units count an internal counter up or down,
at least during block read or block write operations all bus units or at least two bus units compare their internal identifier and the value of the internal counter,
at least during block read or block write operations the bus is accessed, preferably for reading or writing data, by the bus units depending on the result of the comparison, especially if the result of the comparison is positive.

The block/bulk read or block write operation may include all bus units or only a group of the bus units. Signaling before or within block read and block write operations or access may be used to determine the member bus units of the group. The group may comprise for instance all bus units, at least 20 percent of the bus units, at least 50 percent, at least 75 percent of the bus units or all bus units. It is possible to signal a start value and/or an end value of the counter to the bus units before starting the block read. Instead of the end value it is possible to transmit the number of access operations to the bus units, preferably to all bus units, especially by using a broadcast message. Thus it is possible to restrict the read or write to a smaller group of bus units, in order to make it faster and to change only the data in some of the bus units or to read data only from some of the bus units. It is possible to restrict the reading or writing to only one bus unit if necessary.

A method for assembling an input arrangement may comprise:
using at least two bus wires of a bus,
connecting a plurality of bus units in parallel connection to the bus wires,
connecting to the bus wires at least one bus control unit that receives data from the bus units depending on pressed input elements that are electrically connected to the bus units.

The order of these steps may be varied as long as all steps are performed.

The foregoing has outlined rather broadly the features and technical advantages of embodiments of the present invention in order to better understand the detailed description of the invention that follows. Additional features and advantages of embodiments of the invention will be described hereinafter. The embodiments also form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following description taken in conjunction with the accompanying drawings, in which:

FIG. 1 illustrates a bus topology of a bus system,

FIG. 2 illustrates sub units of a bus control unit (MIC),

FIG. 3 illustrates sub units of a bus unit (SLC), and

FIG. 4 illustrates sub units of an interface unit within the bus control unit (MIC), and

FIGS. 5A to 5E illustrate a process flow for address allocation using Schmitt trigger (ST) circuits within bus units (SLC).

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to implement and use the invention, and do not limit the scope of the invention. Moreover, the same reference signs refer to the same technical features if not stated otherwise. As far as “may” is used in this application it means the possibility of doing so as well as the actual technical implementation. As far as “about” is used in this application, it means that also the exact given value is disclosed. The Figures are not drawn to scale, i.e. there may be other dimensions and proportions of the shown elements.

The present invention will be described with respect to the preferred embodiment in a specific context namely an input arrangement in the form of a keyboard with keys as input elements. The invention may also be applied, however, to other input arrangements.

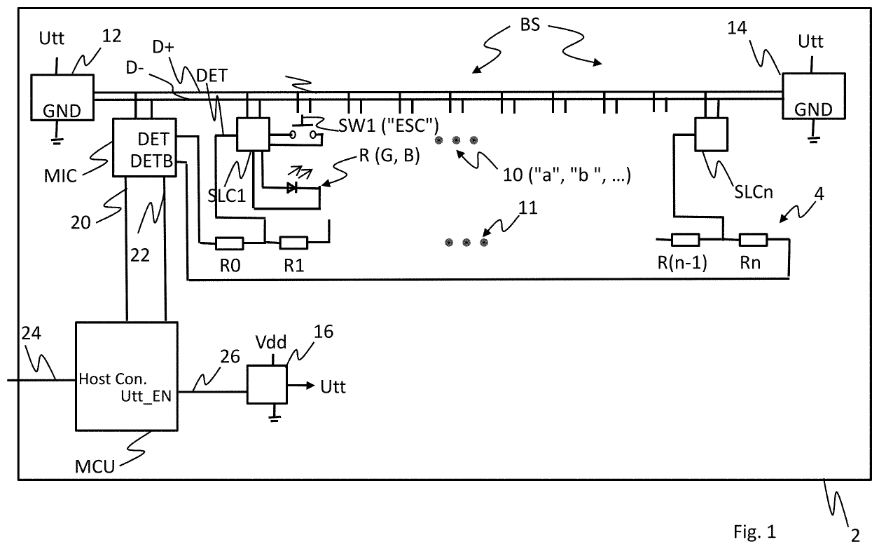

FIG. 1 shows a first bus topology of a bus system BS. In the first bus topology there is one bus control unit MIC that is connected with a chain 4 of resistors R0 to Rn all having the same resistive value within the fabrication tolerance. This means that the MIC is able to perform an address allocation method in order to allocate addresses to the SLC after power on.

However there may be a second bus topology where an MCU is connected to chain 4 of resistors R0 to Rn. In this case the MCU controls the allocation of addresses to SLCs. It is possible to have a further tap that goes from the middle of chain 4 to a further input/output pin of the MCU when using the second topology.

A third topology uses one master MIC and several subordinated MICs on bus system BS. This may allow longer bus wires or more SLCs on bus DHIB. The subordinated MICs are also part of chain 4, i.e. their pins DET and DETB are connected to the left or right with resistors.

A fourth topology uses a master MIC and several bridge MICs that are placed between adjacent bus segments of bus system BS and between segments of chain 4. In this topology, line termination units are located at the ends of the wires of the bus of each bus segment. It is possible to have even longer bus systems using bridge MICs.

It is, of course, possible to combine features of the four topologies to get further topologies.

The first bus topology is described in more detail here. The bus system BS is part of a keyboard 2 that comprises more than 100 keys or key switches, one of them shown as switch SW1 on bus unit SLC1. Switch SW1 is for instance the “ESC” (Escape) key. Although the bus DHIB (Differential Host Interface Bus) of bus system BS is shown along a straight line in FIG. 1, it is clear that the bus DHIB changes its direction several times in a real keyboard 2 so that there are several parallel sections of bus DHIB, for instance 5 to 7 parallel sections.

The resistors R0 bis Rn of chain 4 of resistors are connected in a serial connection beginning with R0, then R1 and so on, see further resistors 11, to the last but not least resistor R(n−1) and to the last resistor Rn. The free end of resistor R0 is connected to a DET output of bus control unit MIC. The free end of resistor Rn is connected to a DETB output of bus control unit MIC. Between two adjacent resistors there are respective taps. The tap between R0 and R1 is connected to bus unit SLC1 input/output pin DET (DETermine). The tap between R1 and R2 is connected to a bus unit SLC2 (not shown, see further bus units 10) and so on. The final tap between resistor R(n−1) and Rn is connected to the last bus unit SLCn on the bus DHIB. The ends of chain 4 may be connected to pins DET, DETB on a bus control unit MIC or on the MCU mentioned later.

Push buttons or key switches, for instance switch SW1, are used to make inputs by a user of the keyboard. Each of those switches is connected to a respective bus unit SLC, i.e. switch SW1 to SLC1 and so on. Optionally the key switches may be lighted by LEDs (Light Emitting Diode) in order to enable the use of the keyboard in dark rooms or in darker rooms as well. LED groups of three LEDs red R, green G and blue B may be coupled to each bus unit SLC respectively. It is possible to control the LED groups and the LED within one group independently from the LEDs of other groups or of other LEDs within the same group.

The bus system BS comprises:
one bus control unit MIC (MIC—Master Interface Controller) in short MIC,
bus units SLC1 to SLCn (SLC subordinated/SLave controller) in short SLC, for instance between 100 and 150 SLCs, and
the bus DHIB (Differential Host Interface Bus) in short DHIB.

The bus DHIB comprises two bus wires D+, D−. Bus wire D+ is for the transmission of the logical positive signal, i.e. signals a logical 1 with positive potential. Bus wire D− is for the transmission of the negative (logically inverse) signal of the differential signal. The bus units SLC1, 10 to SLCn are electrically conductive connected to the bus wires D+ and D− in parallel connection. This means that all other bus units SLC will still work even if one bus unit SLC does not work properly or does not work at all.

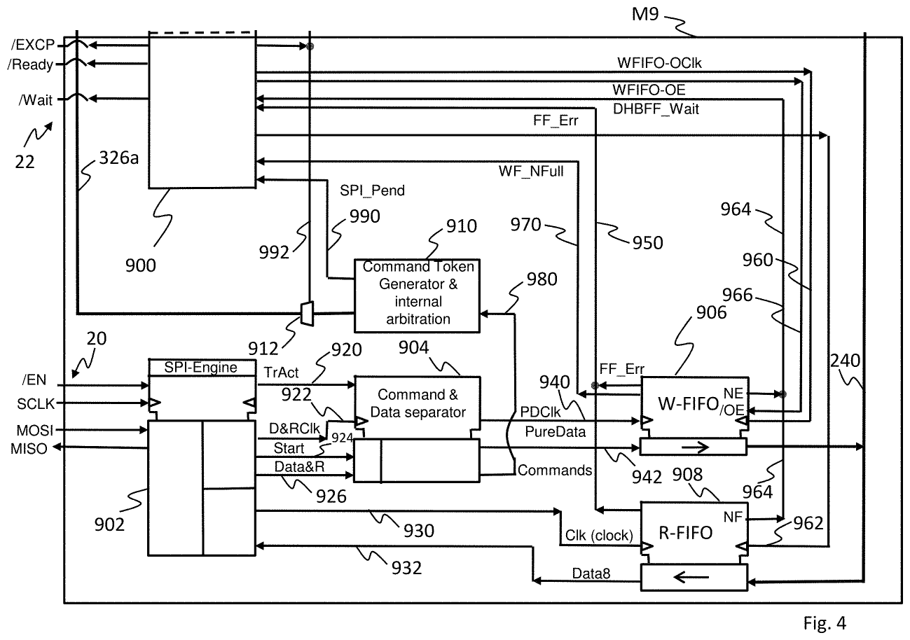

Furthermore, keyboard 2 comprises a processor unit MCU (Microprocessor Control Unit) or in short MCU. Between the MCU and the bus control unit MIC there is an SPI (Serial Peripheral Interface) bus 20, see FIG. 4 for more details. Furthermore, there are control lines 22 between the MCU and the bus control unit MIC. Control lines 22 are also explained in more detail with regard to FIG. 4 below. There is an interface 24, for instance USB (Universal Serial Bus), Bluetooth etc., between the MCU and a further MCU or/and a main processor of a computer. Interface 24 is used to transmit codes that identify the keys of the keyboard 2 that a user of the keyboard has pressed to the main processing unit.

There are two bus termination units 12, 14 at the ends of bus DHIB for line termination, i.e. in order to prevent reflection of signals at the end of the wires D+ and D−. Such reflection would interfere with the transmitted signals. A power unit 16 generates the power, i.e. the power potential Utt, for bus termination units 12, 16. The relevant voltage is derived from ground GND potential and positive potential Vdd. There is an enable line 26 from MCU to power unit 16 that enables or disenables power generation for potential Utt, i.e. for the potential that is relevant for the powering of the line termination units 12 and 14. This may be used for energy saving. Due to biasing termination always may use two potentials. While usually the negative one is GND (ground) and the positive is Utt, there may be applications were it is necessary to move the potentials either further apart (for a very large DHIB) or closer together (for low power tweaking), which both will result in two distinct termination voltages Utt+ and Utt−.

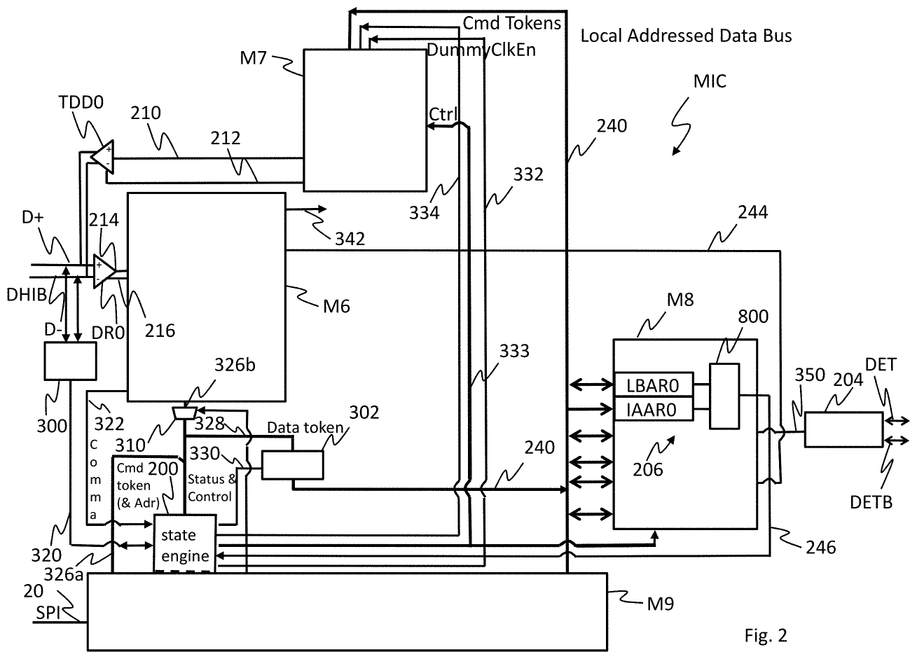

FIG. 2 shows sub units of the bus control unit (MIC):
a state engine 200 of bus control unit MIC that controls the functions of the MIC,
a receiving unit M6 for receiving data and commands from bus DHIB,
a sending unit M7 for sending data and commands to the bus DHIB,
a match and general control unit M8 that is used for addressing and for general control. Only the [IAAR] counting may be specific to implicit addressing.
an interface unit M9 that comprises an interface to and from the processor unit MCU, see FIG. 4 for more details,
a tristate differential driver TDD0 with special state driving (OOB out of band signaling). The two outputs of TDD0 are connected to bus wires D+ and D−.
a differential receiver DR0 with special state detect. The two inputs of TDD0 are connected to bus wires D+ and D−.
a DET control unit 204 having a first output pin DET that is connected to R0 of chain 4 and a second output pin DETB that is connected to the last resistor Rn of chain 4 enabling the MIC to set the ends of chain 4 to low and high during allocation of addresses to SLCs as described in more detail at the end of the description.
an address and match unit 206 that is used for implicit addressing and that comprises an address register LBAR0 (Local Bus Address Register, however it contains the address that is relevant for bus DHIB) and a counter register IAAR0 (Imminent (upcoming) Address Access Register) as well as a match/compare unit 800. The addressing unit as a whole may not be optional, but may be necessary to implement a means of distinguishing the bus stations. Only the IAAR may be definitely optional and LBAR may also be optional, if some sort of “hard wiring” (preprogramming) of the address is used.

There are the following connections between the units of MIC:
data output line 210 for data transmitted to bus DHIB arranged between sending/transmitting unit M7 and input of driver TDD0,
a control line 212 that is between sending unit M7 (may also be named as transmitting unit) and the control input of driver TDD0,
a data input line 214 for data received from bus DHIB arranged between the output of receiver DR0 and receiving unit M6,
a control line 216 from receiving unit to a control input of receiver DR0,
SPI interface lines 20 between processor unit MCU and interface unit M9, see FIG. 4 for more details,
a local addressed data bus 240 that may comprise a data bus and an address bus separated from each other or multiplexed. Bus 240 is between state engine 200, sending unit M7 and the match and general control unit M8.
control lines 244 between receiving unit M6 and unit M8,
a match control line 246 between unit M8 and state engine 200 for the signaling of a match of addresses LBAR0, IAAB0 in match unit 800.

Furthermore, bus control unit MIC comprises:
an exception signaling unit 300 having two inputs connected to bus DHIB and being able to detect or to initiate out of band signaling (OOB),
a data buffer register 302 for intermediate storing of data tokens received via bus DHIB,
a bus gate unit 310 for enabling data transfer from receiving unit M6 via received token bus 326b to state engine 200, i.e. for preventing transmission conflicts. This bus gate unit 310 is an enable gate. The other source of command tokens is the command token generator unit and internal arbitration unit 910, see FIG. 4, under control of the SPI engine 902, see FIG. 4. The state engine 200 is a pure sink for the commands, or execution unit. Nevertheless the state engine 200 selects the source to obtain the next command queued in from: If a command from SPI engine 902 is pending it selects command token generator (CTG) unit and internal arbitration unit 910 as source and on demand even can actively terminate the present command to execute the one from the SPI engine 902. In most modern FPGA&ASIC implementations “busses” will not be implemented by separate transceivers for each source, but by a mux, which intrinsically prevents conflicts.
a bidirectional signaling line 320 between exception signaling unit 300 and state engine 200, For easier implementation this may be a three line point to point bus, not just one line:
Enable (exception out) signal to the OOB (out of band—signaling) driver, i.e. exception signaling unit 300,
OOB signal state indicator (exception in) to the state engine 200, and
OOB data line (bidir).
a comma or separator signaling line 322 from receiving unit M6 to state engine 200,
the command token and address bus 326a for the transmission of command tokens from receiving unit M6 or from the command token generator (CTG) unit and internal arbitration unit 910 to state engine 200,
the received token bus 326b for the transmission of received tokens from receiving unit M6 to state engine 200 and of data and address tokens from receiving unit M6 via data buffer register 302 to local addressed data bus 240. Each token may consist of 8 bit and may be flagged by a ninth one either as data or as command. An address token thereby may be a data token that due to the preceding command is going to be interpreted as an address or as extension of a command (flags, etc.) by “addressing” a sub-command. Thereby addresses may mainly be handled by the data paths. They may just interpreted differently due to the control exerted by the state engine 200. Therefore most address tokens just will be transferred to the [IAAR] (Imminent Access Register) or another address related register.
a data token bus 328 for the transmission of data tokens from receiving unit M6 to local addressed data bus 240 via a data buffer register 302. Since on this data token bus 328 data tokens, which are not being interpreted as command extension, only can originate in receiving unit M6, this data token bus 328 also could be a branch of received token bus 326b rather than command token and address bus 326a. This will be determined by implementation needs.
status and control line(s) 330 between state engine 200 and data buffer register 302,
a dummy clock enable line 332 from state engine 200 to sending unit M7 for controlling the generation of dummy clock data on bus DHIB,
control lines 333 from state engine 200 to sending (transmitting) unit M7 and match and general control unit M8 for general control purposes,
a command token bus line 334 from state engine 200 to sending unit M7 for the transmission of command tokens that shall be transmitted via bus DHIB to the SLCs,
a synchronization clock line 342 that transmits a clock signal to all other units of MIC especially while receiving data via bus DHIB. The clock signal is generated inside receiving unit M6.
a bus line 350 between match and general control unit M8 and DET control unit 204 for transmitting data that sets high or low state at the DET and DETB pins of control unit 204.

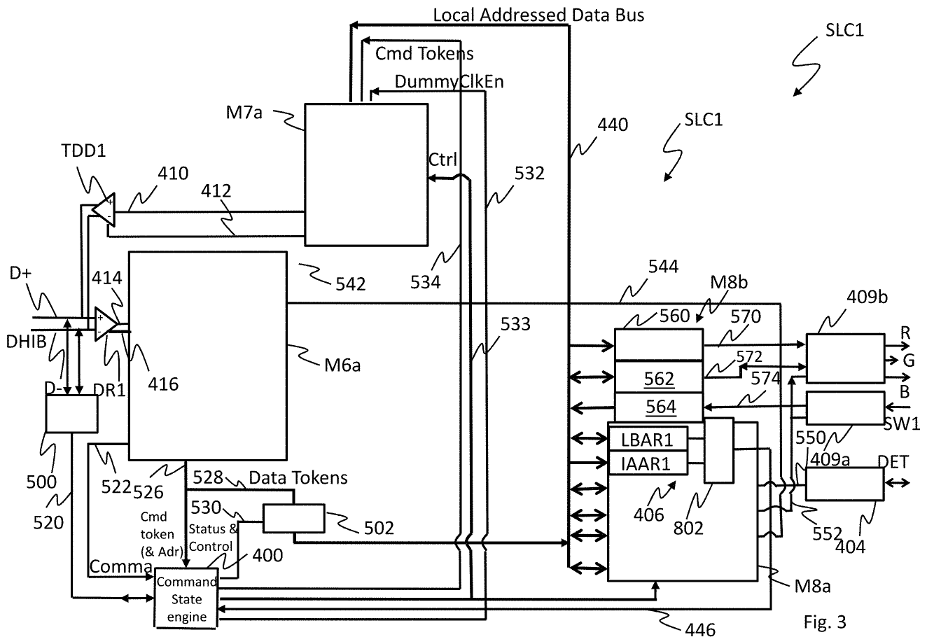

FIG. 3 shows sub units of a bus unit (SLC), for instance of SLC1. There are the following similarities between the MIC shown in FIG. 2 and the SLC1 shown in FIG. 3. With regard to the connection of these elements reference is made to the respective elements that have been described with regard to FIG. 2 above. The corresponding elements are shown in round brackets: state engine 400 (SLC) (200 MIC), receiving unit M6a (M6), sending unit M7a (M7), match and general control unit M8a (M8), DET control unit 404 (204), address and match unit 406 (206), address register LBAR1 (LBAR0), counter register IAAR1 (IAAR0), match unit 802 (800), tristate differential driver TDD1 (with special state driving) (TDD0), differential receiver DR1 (with special state detect) (DR0), data output line 410 (to bus) (210), control line 412 (212), data input line 414 (from bus) (214), control line 416 (216), local addressed data bus 440 (data bus and address bus separate or multiplexed) (240), match control line 446 (246), exception signaling unit 500 (300), data buffer register 502 (302), signaling line 520 (320), comma signaling line 522 (322), data token bus 528 (328), status and control line 530 (330), dummy clock enable line 532 (332), control lines 533 (333), command token line 534 (334), synchronization clock 542 (342), connection lines 550 (350).

There are the following differences:
address register LBAR1 (LBARn) and counter register IAAR1 (IAARn) are mandatory,
the DET control unit 404 does not have a second input/output pin, i.e. DETB,
a switch sample unit 409a that is coupled to key switch SW1 and that determines how deep key switch SW1 is pressed down,
an LED control engine 409b that is coupled to one, two or three LEDs, i.e. a red one R, a green one G and a blue one B, or to more than three LEDs,
a command token and address bus 526 from receiving unit M6a to state engine 400. There is no bus gate unit in the SLC corresponding to bus gate unit 310. Furthermore, there is no bus that corresponds to bus 326a because of missing interface unit M9 in SLCs.
connection lines 552 from unit M8a to switch sample unit 409a and to LED control engine 409. It is for instance possible to transmit the state of control flags via lines 552.

Furthermore, there is a second part M8b of match and general control unit M8a of SLC, SLC1 comprising:
a register 560 (ILPCDR—Intermediate LED (light emitting diode) PWM control register) for controlling PWM (pulse width modulation) of the LEDs R, G and B,
a register 562 (ILDCDR and LSTAT—Intermediate LED dot correction control register and LED status register) for controlling further functions of the LEDs, i.e. bin correction, on/off etc., and
a register 564 (ISSOR—Intermediate switch sample output register) that stores the sample value that is sampled from switch SW1 for instance using an ADC.

A connection line 570 is between register 560 and LED control engine 409b. A further connection line 572 is between register 562 and LED control engine 409b. A third connection line 574 is between register 564 and switch sample unit 409a. All three registers 560, 562 and 564 are also connected to local addressed data bus 440, i.e. register 560 for write access, register 562 for read or write access and register 560 for read access. Further registers DCR0 to DCR3 of match and general control unit M8a and M8b will be described below.

The receiving unit M6, M6a may comprise:
an edge detector and filter unit that receives its input from receiver DR0 or DR1,
a clock recuperation and synchronization unit that may receive its input from the edge detector and filter unit,
a phase alignment unit that may receive input from receiver DR0 or DR1 and from clock recuperation and synchronization unit,
a 10 bit shifter unit that may be coupled to the phase alignment unit,
a history buffer that may store the previously received symbol,
a modified 8b/10b decoder, the optional modifications may be made with regard to a decoder as described in the article of A. X. Widmer, Peter A. Franaszek that is mentioned above. Some of the modifications will be explained below in more detail. The modified 8b/10b decoder may receive its input from the 10 bit shifter and from the history buffer.
a comma detection unit that detects the comma separator of the frames transmitted on bus DHIB and signals its presence to the respective state engine 200 or 400. The comma detection unit may be closely coupled to the modified 8b/10b decoder.
a command detection unit for detecting commands that have been transmitted via the bus DHIB.

An output of the clock recuperation and synchronization unit may output a synchronization clock on line 342 or 542 for other units of the MIC or SLC. Furthermore clock recuperation and synchronization unit may be coupled to control lines 244 (544). The command detection unit may be coupled to received token bus 326b (526).

The sending (transmitting) unit M7, M7a may comprise:
a data out buffer and special code insertion unit,
an out FIFO unit that may store 4 tokens for example and that receives its inputs from the data out buffer and special code insertion unit,
a modified or unmodified 8b/10b encoder unit that receives its input from the out FIFO unit, and
a 10b (bit) output shifter unit that receives its input from the modified 8b/10b encoder.

The local addressed data bus 240 or 440 is connected to the input of data out buffer and special code insertion unit which also receives command tokens via command token line(s) 332 respectively 532. Dummy clock enable line 332 is also connected with data out buffer and special code insertion unit. The output of the 10b output shifter unit is connected with the input of driver TDD0 or TDD1. All units except the FIFO unit are controlled by the control lines 333.

In addition to the registers LBAR0 (Local Bus Address Register) and IAAR0 (Imminent Access Address Register, counter register) as well as to the match unit 800 the match and general control unit M8 comprises the registers that are mentioned in the following. In addition to the registers LBAR1 (Local Bus Address Register) and IAAR1 (Imminent Access Address Register, counter register) as well as to the match unit 802 the match and general control unit M8a also comprises the registers that are mentioned in the following:
register DCR0 that has a bidirectional connection to DET (Determine) control unit 204 or to DET control unit 404,
register DCR1 that is connected with lines 552 in unit M8a. These may be several lines carrying the control bits from [DCR1]: enable, mode bits, test flags, etc.
register DCR2 that is connected with control lines 244, 544, and
register DCR3 that may be used for other purposes.

Local addressed data bus 240, 440 is connected bidirectional, i.e. for sending and receiving, to all four registers DCR0 to DCR3 in both units M8 and M8a. Control lines 244, 544 carry control bits, mostly clock mode controls, from DCR2 to receiving unit M6 and M6a and allow the read back of some status bits from the receiving unit M6, M6a.

FIG. 4 shows sub units of an interface unit M9 within the bus control unit (MIC). The interface unit M9 comprises:
a second part 900 of state machine/engine of bus control unit MIC,
an SPI (Serial Peripheral Interface) engine 902 that is available in the market,
a command and data separator unit 904,
an input FIFO 906 (W-FIFO—write First In First Out)
an output FIFO 908 (R-FIFO—read FIFO),
a command token generator (CTG) unit and internal arbitration unit 910 creating internal command tokens to be executed by the state machine 200 upon receiving a transfer from SPI for the DHIB or for local register access. Some very basic commands will be directly processed by the CTG by arbitrating internal control lines, for example “hard” resetting the chip. Since the state engine 200 is built for processing DHIB commands, any command coming in via SPI is translated into an appropriate local command token, which will be executed the normal way by the state machine 200, like in an SLC. In order to distinguish those locally created tokens from those received via the DHIB tokens may be used that have no legal symbol encoding on the DHIB, but nevertheless share most of the bit pattern with their functional DHIB equivalent. In execution there is no difference except of the data flow: Commands transferring data to DHIB are using the W-FIFO as data source instead of the register file of match and general control unit M8, while commands transferring data from DHIB are using the R-FIFO instead of the register file. Local transfers (between local register file and the SPI) are replacing the receiving unit M6 and sending unit M7 by the appropriate FIFO. Though a few commands do not fit into this scheme like “RESET”, local power down and unlocking setup bits that in their present state are explicitly protected from changing by a DHIB access. These commands are directly executed by the CTG by directly arbitrating the appropriate control lines.
a bus gate 912 between the output of unit 910 and command token and address bus 326a,
an exception output line /EXCP as part of control lines 22,
a “ready” output line /Ready as part of control lines 22
a “wait” output line /Wait as part of control lines 22
an “enable” input line /EN as part of the standard SPI interface 20,
a clock line SCLK as part of the standard SPI interface 20,
an input line MOSI as part of the standard SPI interface 20,
an output line MOSO as part of the standard SPI interface 20,
a transaction indicator line 920 between SPI engine 902 and unit 904 indicating a continuous transaction,
a clock line 922 between SPI engine 902 and unit 904,
a start signaling line 924 between SPI engine 902 and unit 904,
a set of parallel data lines 926 between SPI engine 902 and unit 904,
a clock line 930 for R-FIFO 908 between SPI engine 902 and output FIFO 908,
a data output line 932 of R-FIFO 908 connected with an input of SPI engine 902,
an input clock line 940 of input or W-FIFO 906 coming from command and data separator unit 904,
a data input line 942 of input or W-FIFO 906 coming from command and data separator unit 904,
an error signaling line 950 (FF_Err) coming from FIFOs 906, 906 and going to the second part 900 of the state engine of the bus control unit MIC signaling an error, for instance overflow or underflow of data,
an output clock line 960 of W-FIFO 906 going to second part 900 of state engine,
an input clock line 962 of R-FIFO 908 coming from second part 900 of state engine,
a bus wait line 964 coming from output NE (nearly empty) of input FIFO 906 and from output NF (nearly full) of output FIFO 908 and connected to second part 900 of state machine, i.e. forming a signal DHIBFF_Wait. In the diagram these lines are shown as a “wire or” which may be not available in modern chips any more. So the creation of DHIBFF_Wait probably will be implemented using a “real” or gate.
an output enable/disable line 966 connected to a respective input of W-FIFO 906 for controlling and synchronizing data output to the local addressed data bus,
a control line 970 (WFF_NFull) coming from a respective control output of input FIFO 906 and going to the second part 900 of state engine for signaling that input FIFO 906 is nearly full,
a command signal line 980 from command and data separator unit 904 to command token unit and internal arbitration unit 910,
a control line 990 (SPI_Pend) from unit 910 to second part 900 of state engine 200 for signaling that SPI data has been received, and
bus gate control line 992 from second part 900 of state engine 200 to bus gate 912 for opening or closing this electronic gate 912. Bus control line 992 is also connected to bus gate 310, see FIG. 2.

Local addressed data bus 240 is also connected with data output of input FIFO 906 and with data input of output FIFO 908.

There are for instance the following methods for allocating addresses to bus units SLCs and/or to subordinated bus control units MICs at bus DHIB.

First Method:
using ADCs within the bus units SLC and/or within the subordinated bus control units MIC and a chain 4 of resistors R0 to Rn,
pull first end of chain 4 to low and pull second end of chain 2 to high potential,
sample all taps of chain 4 at the same time,
use sample values as part of addresses for the SLCs/subordinated MICs, and
optionally: read all possible addresses and rearrange in order to get address space without gaps.

Second Method:
same as first method but partitioning of address space is used in order to form partitions that allow sampling of the values on the taps of resistor chain only for a segment/partition. SLCs in previous partition may pull taps to low and SLCs in following partitions may pull taps to high. The resolution of potential values in the respective “middle” partition is improved considerably reducing detection errors and influence of interference. This may be done for all segment/partitions.

Third Method:
same as second method but with using a uniting of two adjacent partitions combined with sampling of values only within the united partition. This may reduce further errors during the allocation of addresses.

Fourth method: using Schmitt trigger circuits on the taps of chain 4 of resistors R0 to Rn.

Fifth method: Using one of the first method to the fourth method and storing the addresses that have been allocated in a non-volatile memory for further use after allocation.

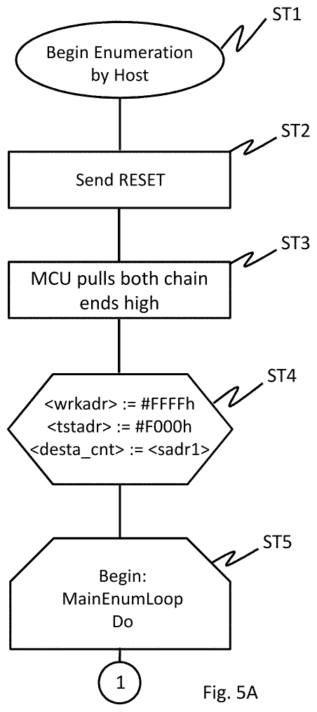

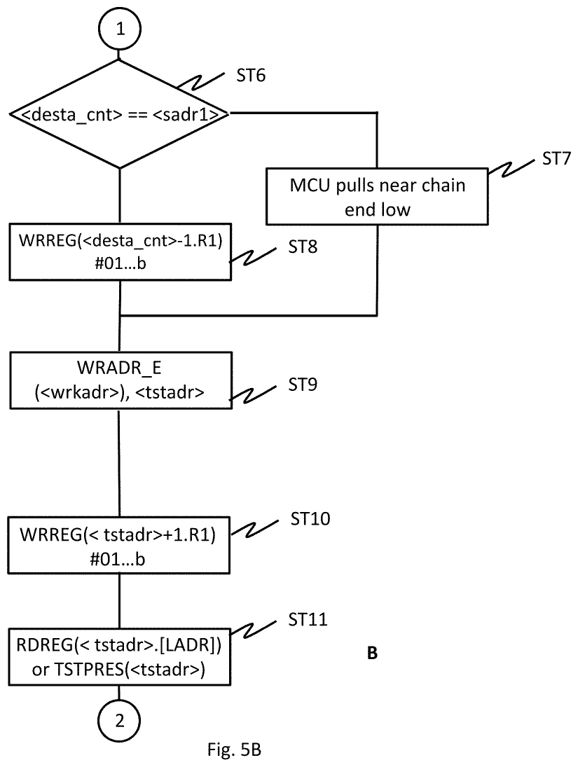

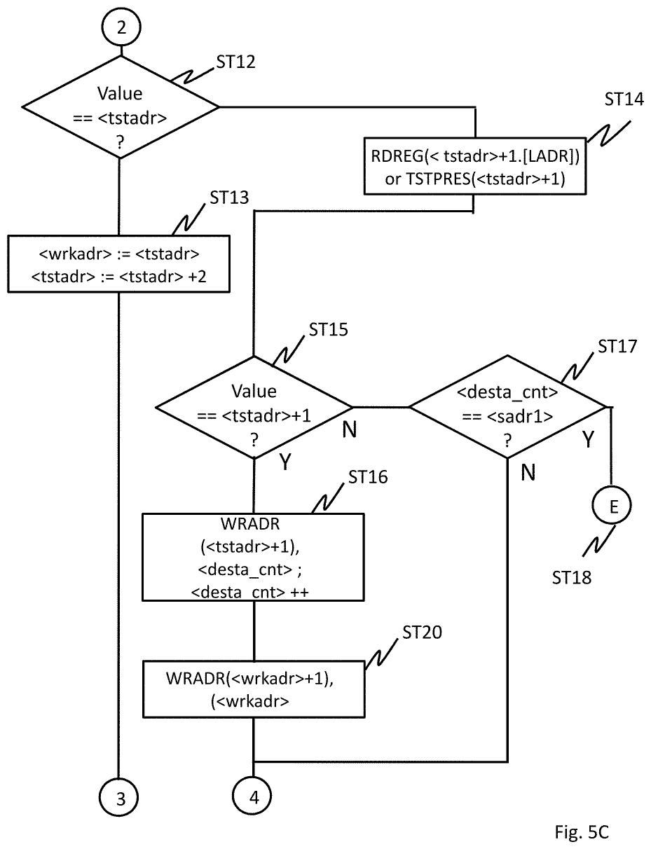

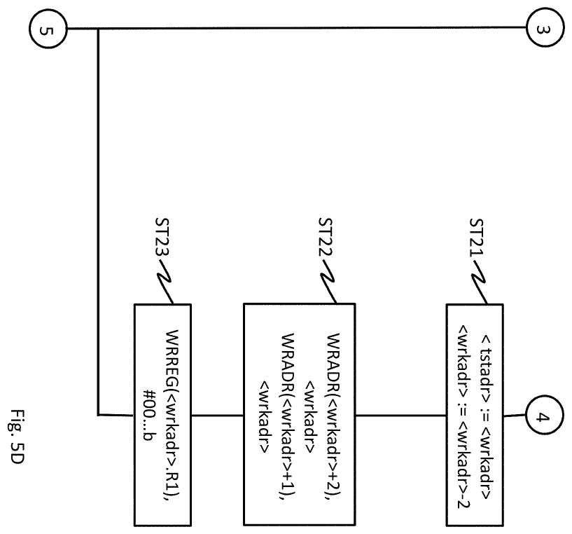

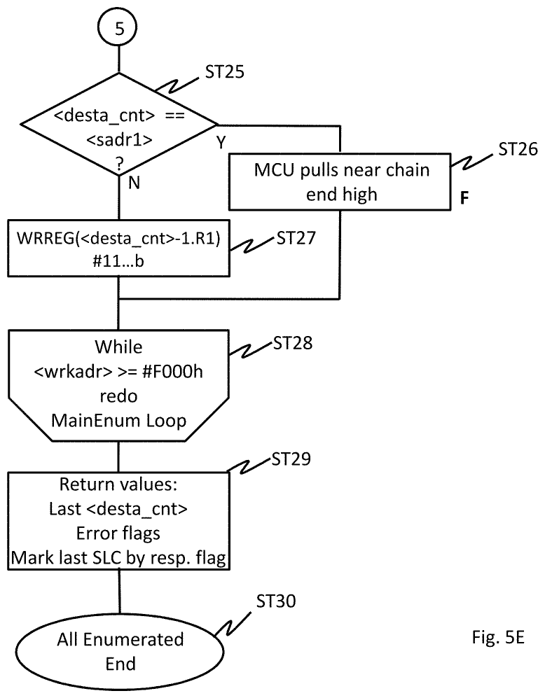

Using the process flow shown in FIG. 5A to FIG. 5E the allocation goes on as shown in the following table. Z means a high ohmic output state on the DET pins of DET control units 404 of SLCs and subordinated MICs if any. The Schmitt trigger circuits may be centered to half Vdd and may have a range of for instance 0.8 Volt if Vdd is 3.3 Volt for instance. The letters A to D that are shown in FIGS. 5A to 5E are also used in the following table in order to ease the orientation, i.e. the mapping between both kinds of descriptions for the same allocation method. The table has a left part, a middle part and a right part which have to be put together using the same line numeration.

There is a command TSTPRES (<tstadr>) that was not mentioned above but which has the same function as the command RDREG (<tstadr>.[LBAR]) that was mentioned above. Basically it replaces the RDREG(<tstadr>.[LBAR]) and the subsequent decision must be replaced by a decision like “SLC found ?”. The decisions to be replaced are at the end of FIG. 5B (step ST11) and at the upper right of FIG. 5C (step ST14). Step ST14 has to be replaced by TSTPRES (<tstadr>+1). The directly following decision has to be rewritten as “SLC found?”, i.e. step ST12 and step ST15.

Register R1 refers to the DET control unit. The left bit stands for the pin value. A write to the DET pin sets the DET pin to the pin value of the left bit. A read to the DET pin reads the external to the left bit. The second bit from left is 1 for output mode and 0 for input mode. If input mode is active, i.e. the second bit is 0 this means that the DET pin is high ohmic connected to chain 4, i.e. state “Z”. If the DET pin is in output mode, i.e. the second bit is 1 the DET pin is driven with the value set by the first bit.

x0 (00 or 10): DET pin is in input mode, for instance step ST23, high ohmic, result of input read is 0 if DET pin is pulled high externally and 1 if it is pulled low externally. The output bit value (first bit) is ignored in input mode. A read always directly will read the external value.

01: output zero, for instance step ST8,

11: output one, for instance step ST10, ST27.

The addresses of all SLCs are not shown in every line of the table. In order to ease understanding the addresses are mainly shown if there is a change in addresses.

This is the left part of the table:

| | Command | | | | |
|---|---|---|---|---|---|
| 1 | (Symbolic) | Mark | Command/State | Det In | Det Out |
| 2 | | | Reset & Ends High | 111111 | ZZZZZZ |
| 3 | | | | | |
| 4 | | A | Near End := Low | 001011 | |
| 5 | WRADR_E (<wrkadr>), | | WRADR_E | | |
| | <tstadr> | | (#FFFFh), #F000h | | |
| 6 | WRREG (<tstadr> + 1.R1), | | WRREG | 011111 | ZZ1Z11 |
| | #11 . . . b | | (#F001h.Ra), | | |
| | | | #11 . . . b | | |
| 7 | TSTPRES (<tstadr>) | B | TSTPRES | | |
| | | | (#F000h) | | |
| 8 | | F | Near End := High | 111111 | ZZ1Z11 |
| 9 | | | | | |
| 10 | | A | Near End := Low | 011111 | ZZ1Z11 |
| 11 | WRADR_E (<wrkadr>), | | WRADR_E | | |
| | <tstadr> | | (#F000h), #F002h | | |
| 12 | WRREG (<tstadr> + 1.R1), | | WRREG | 011111 | Z11Z11 |
| | #11 . . . b | | (#F003h.R1), | | |
| | | | #11 . . . b | | |
| 13 | TSTPRES (<tstadr>) | B | TSTPRES | | |
| | | | (#F002h) | | |
| 14 | | F | Near End := High | 111111 | Z11Z11 |
| 15 | | | | | |
| 16 | | A | Near End := Low | 111111 | Z11Z11 |
| 17 | WRADR_E (<wrkadr>), | | WRADR_E | | |
| | <tstadr> | | (#F002h), #F004h | | |
| 18 | WRREG (<tstadr> + 1.R1), | | WRREG | 111111 | 111Z11 |
| | #11 . . . b | | (#F005h.R1), | | |
| | | | #11 . . . b | | |
| 19 | TSTPRES (<tstadr>) | B | TSTPRES | | |
| | | | (#F004h) | | |
| 20 | TSTPRES | C | TSTPRES | | |
| | (<tstadr> + 1) | | (#F005h) | | |
| 21 | WRADR(<tstadr> + 1), | | WRADR(#F005h), | | |
| | <desta_cnt> | | #0000h | | |
| 22 | WRADR(<wrkadr> + 1), | | WRADR(#F003h), | | |
| | <wrkadr> | | #F002h | | |
| 23 | | | (Rollback shelved) | | |
| 24 | WRADR(<wrkadr> + 2), | | WRADR(#F002h), | | |
| | <wrkadr> | | #F000h | | |
| 25 | WRADR(<wrkadr> + 1), | | WRADR(#F001h), | | |
| | <wrkadr> | | #F000h | | |
| 26 | WRREG (<wrkadr>.R1), | | WRREG | 111111 | 1ZZZZZ |
| | #00 . . . b | | (#F000h.R1), | | |
| | | | #00 . . . b | | |
| 27 | | F | Near End := High | 111111 | 1ZZZZZ |
| | | | (1^{st} SLC) | | |
| 28 | | | | | |
| 29 | | A | Near End := Low | 000111 | 0ZZZZZ |
| | | | (1^{st} SLC) | | |
| 30 | WRADR_E (<wrkadr>), | | WRADR_E | | |
| | <tstadr> | | (#F000h), #F002h | | |
| 31 | WRREG (<tstadr> + 1.R1), | | WRREG | 001111 | 0ZZ111 |
| | #11 . . . b | | (#F003h.R1), | | |
| | | | #11 . . . b | | |
| 32 | TSTPRES (<tstadr>) | B | TSTPRES | | |
| | | | (#F002h) | | |
| 33 | | F | Near End := High | 111111 | 0ZZ111 |
| | | | (1^{st} SLC) | | |
| 34 | | | | | |
| 35 | | A | Near End := Low | 001111 | 0ZZ111 |
| | | | (1^{st} SLC) | | |
| 36 | WRADR_E (<wrkadr>), | | WRADR_E | | |
| | <tstadr> | | (#F002h), #F004h | | |
| 37 | WRREG (<tstadr> + 1.R1), | | WRREG | 001111 | 0Z1111 |
| | #11 . . . b | | (#F005h.R1), | | |
| | | | #11 . . . b | | |
| 38 | TSTPRES (<tstadr>) | B | TSTPRES | | |
| | | | (#F004h) | | |
| 39 | | F | Near End := High | 111111 | 1Z1111 |
| | | | (1^{st} SLC) | | |
| 40 | | | | | |
| 41 | | A | Near End := Low | 011111 | 0Z1111 |
| | | | (1^{st} SLC) | | |
| 42 | WRADR_E (<wrkadr>), | | WRADR_E | | |
| | <tstadr> | | (#F004h), #F006h | | |
| 43 | WRREG (<tstadr> + 1.R1), | | WRREG | 001111 | 011111 |
| | #11 . . . b | | (#F007h.R1), | | |
| | | | #11 . . . b | | |
| 44 | TSTPRES (<tstadr>) | B | TSTPRES | | |
| | | | (#F004h) | | |
| 45 | TSTPRES | C | TSTPRES | | |
| | (<tstadr> + 1) | | (#F005h) | | |
| 46 | WRADR(<tstadr> + 1), | | WRADR(#F007h), | | |
| | <desta_cnt> | | #0001h | | |
| 47 | WRADR(<wrkadr> + 1), | | WRADR(#F005h), | | |
| | <wrkadr> | | #F004h | | |
| 48 | | | (Rollback to | | |
| | | | shelved) | | |
| 49 | WRADR(<wrkadr> + 2), | | WRADR(#F004h), | | |
| | <wrkadr> | | #F002h | | |
| 50 | WRADR(<wrkadr> + 1), | | WRADR(#F003h), | | |
| | <wrkadr> | | #F002h | | |
| 51 | WRREG (<wrkadr>.R1), | | WRREG | 000111 | 01ZZZZ |
| | #00 . . . b | | (#F002h.R1), | | |
| | | | #00 . . . b | | |
| 52 | | F | Near End := High | 011111 | 01ZZZZ |
| | | | (2^{nd} SLC) | | |
| 53 | | | | | |

This is the middle part of the table:

| | | | | | | |
|---|---|---|---|---|---|---|
| 1 | Adr- | Adr- | Adr- | Adr - | Adr- | Adr- |
| | (SLC1) | (SLC2) | (SLC3) | (SLC4) | (SLC5) | (SLC6) |
| 2 | #FFFFh | #FFFFh | #FFFFh | #FFFFh | #FFFFh | #FFFFh |
| 3 | | | | | | |
| 4 | #FFFFh | #FFFFh | #FFFFh | #FFFFh | #FFFFh | #FFFFh |
| 5 | #F000h | #F000h | #F001h | #F000h | #F001h | #F001h |
| 6 | #F000h | #F000h | #F001h | #F000h | #F001h | #F001h |
| 7 | | | | | | |
| 8 | | | | | | |
| 9 | | | | | | |
| 10 | | | | | | |
| 11 | #F002h | #F003h | #F001h | #F003h | #F001h | #F001h |
| 12 | | | | | | |
| 13 | | | | | | |
| 14 | | | | | | |
| 15 | | | | | | |
| 16 | | | | | | |
| 17 | #F005h | #F003h | #F001h | #F003h | #F001h | #F001h |
| 18 | | | | | | |
| 19 | | | | | | |
| 20 | | | | | | |
| 21 | #0000h | #F003h | #F001h | #F003h | #F001h | #F001h |
| 22 | #0000h | #F002h | #F001h | #F002h | #F001h | #F001h |
| 23 | | | | | | |
| 24 | #0000h | #F000h | #F001h | #F000h | #F001h | #F001h |
| 25 | #0000h | #F000h | #F000h | #F000h | #F000h | #F000h |
| 26 | | | | | | |
| 27 | | | | | | |
| 28 | | | | | | |
| 29 | | | | | | |
| 30 | #0000h | #F002h | #F002h | #F003h | #F003h | #F003h |
| 31 | | | | | | |
| 32 | | | | | | |
| 33 | | | | | | |
| 34 | | | | | | |
| 35 | | | | | | |
| 36 | #0000h | #F004h | #F005h | #F003h | #F003h | #F003h |
| 37 | | | | | | |
| 38 | | | | | | |
| 39 | | | | | | |
| 40 | | | | | | |
| 41 | | | | | | |
| 42 | #0000h | #F007h | #F005h | #F003h | #F003h | #F003h |
| 43 | | | | | | |
| 44 | | | | | | |
| 45 | | | | | | |
| 46 | #0000h | #0001h | #F005h | #F003h | #F003h | #F003h |
| 47 | #0000h | #0001h | #F004h | #F003h | #F003h | #F003h |
| 48 | | | | | | |
| 49 | #0000h | #0001h | #F002h | #F003h | #F003h | #F003h |
| 50 | #0000h | #0001h | #F002h | #F002h | #F002h | #F002h |
| 51 | | | | | | |
| 52 | | | | | | |
| 53 | | | | | | |

And this is the right part of the table:

| 1 | Comment | wrkadr | tstadr | desta_cnt |
|---|---|---|---|---|
| 2 | | #FFFFh | #F000h | #0000h |
| 3 | | | | |
| 4 | | | | |
| 5 | | | | |
| 6 | | | | |
| 7 | Some SLC with Adr.LSB:=0 ? → Here: | #F000h | #F002h | |
| | Yes | | | |
| 8 | | | | |
| 9 | | | | |
| 10 | | | | |
| 11 | | | | |
| 12 | ST of SLC1 still low! | | | |
| 13 | Some SLC with Adr.LSB:=0 ? → Here: | #F002h | #F004h | |
| | Yes | | | |
| 14 | | | | |
| 15 | | | | |
| 16 | With only one SLC in low end portion | | | |
| | the Schmitt-T stays high | | | |
| 17 | | | | |
| 18 | | | | |
| 19 | Some SLC with Adr.LSB:=0 ? → Here: | | | |
| | No | | | |
| 20 | Some SLC with Adr.LSB:=1 ? → Here: | | | |
| | Yes | | | |
| 21 | | | | #0001h |
| 22 | | | | |
| 23 | Rollback to shelved SLCs. Stop and | #F000h | #F002h | |
| | assess, if wrkadr becomes <#F000h | | | |
| 24 | | | | |
| 25 | | | | |
| 26 | | | | |
| 27 | | | | |
| 28 | | | | |
| 29 | | | | |
| 30 | | | | |
| 31 | | | | |
| 32 | Some SLC with Adr.LSB:=0 ? → Here: | #F002h | #F004h | |
| | Yes | | | |
| 33 | | | | |
| 34 | | | | |
| 35 | | | | |
| 36 | | | | |
| 37 | | | | |
| 38 | Some SLC with Adr.LSB:=0 ? → Here: | #F004h | #F006h | |
| | Yes | | | |
| 39 | | | | |
| 40 | | | | |
| 41 | | | | |
| 42 | | | | |
| 43 | | | | |
| 44 | Some SLC with Adr.LSB:=0 ? → Here: | | | |
| | No | | | |
| 45 | Some SLC with Adr.LSB:=1 ? → Here: | | | |
| | Yes | | | |
| 46 | | | | #0002h |
| 47 | | | | |
| 48 | Rollback to shelved SLCs. Stop and | #F002h | #F004h | |
| | assess, if wrkadr becomes <#F000h | | | |
| 49 | | | | |
| 50 | | | | |
| 51 | | | | |
| 52 | | | | |
| 53 | | | | |

The steps are repeated until all SLCs have their final address, i.e. in the example also SLC3 to SLC6. At the end of the procedures some steps may be performed to clear some variables etc.

Using the gist of the shown embodiment for the Schmitt trigger circuits and using the messages and tokens used in this embodiment it is possible for the person skilled in the art to realize also the first three methods for allocating addresses mentioned above without undue burden or effort.

Although embodiments of the present invention and their advantages have been described in detail above, it should be understood that various changes, substitutions and alterations can be made therein without departing from the spirit and scope of the invention as defined by the appended claims. For example, it will be readily understood by those skilled in the art that many of the features, functions, processes and methods described herein may be varied while remaining within the scope of the present invention. Moreover, the scope of the present application is not intended to be limited to the particular embodiments of the system, process, manufacture, method or steps described in the present invention. As one of ordinary skill in the art will readily appreciate from the disclosure of the invention systems, processes, manufacture, methods or steps presently existing or to be developed later that perform substantially the same function or achieve substantially the same result as the corresponding embodiments described herein may be utilized according to the present invention. Accordingly, the appended claims are intended to include within their scope such systems, processes, methods or steps.

It is possible to combine the embodiments of the introduction with each other. Furthermore, it is possible to combine the examples of the description of Figures with each other. Further, it is possible to combine the embodiments of the introduction and the examples of the description of Figures.

1. An input arrangement comprising
at least two 2 bus wires of a bus,
at least 10 or at least 100 bus units which are electrically connected to the bus wires and which respectively are electrically connected to at least one input element,
wherein the bus units are electrically connected in parallel connection to the bus wires.

2. The input arrangement according to claim 1, wherein the bus units comprise respectively:
a storage cell for storing an identifier, especially an address, that identifies the respective bus unit with regard to the other bus units on the same bus wires in an unambiguous way,
a counter unit,
a comparison unit, and
a bus access unit that accesses the bus depending on an output signal of the comparison unit,
wherein preferably all bus units have the same internal structure.

3. The input arrangement according to claim 1, wherein the bus units comprise:
at least one LED,
at least one storage cell for storing data that is used for driving or controlling of the at least one LED, preferably data that is used to control the brightness or to calibrate the brightness of the at least one LED,
and/or wherein each bus unit comprises an analog digital converter whose input is electrically connected with a potentiometer, whereby the potentiometer is mechanically coupled with the input element.

4. The input arrangement according to claim 1, wherein the bus units comprise:
a state machine,
and/or wherein a bus protocol for data transmission via the bus wires is implemented in the bus units, preferably a bus protocol that uses an 8b/10b encoding and/or an 8b/10b decoding.

5. The input arrangement according to claim 1, whereby at least one bus control unit is electrically connected to the bus wires, wherein the bus control unit comprises:
a state machine,
and preferably an interface unit to an external processor unit, especially an SPI unit and/or an input data memory, preferably an input FIFO, that is used for data transmission from the processor unit to the bus control unit,
and preferably an output data memory, especially an output FIFO, that is used for data transmission from bus control unit to the processor unit.

6. The input arrangement according to claim 5, whereby a bus protocol for data transmission via the bus wires implemented in the bus control unit comprises a decoding unit and an encoding unit, preferably an 8b/10b decoding unit and an 8b/10b encoding unit.

7. The input arrangement according to claim 5, wherein the bus control unit comprises:
a storage cell for storing an identifier, especially an address, that identifies the respective bus control unit with regard to other bus control units on the same bus wires in an unambiguous way,
a counter unit,
a comparison unit, and
a bus access unit that accesses the bus depending on an output signal of the comparison unit,
wherein preferably at least two bus control units are electrically connected to the bus wires, the at least two bus control units having preferably the same internal structure.

8. The input arrangement according to claim 1, and wherein each bus unit preferably comprises a receiver unit which receives data according to a differential signal transmitting method, and
wherein preferably a chain of electronic elements is used, for instance of resistors or capacitors or both of resistors and capacitors, especially with taps between the elements connected to an input of a respective bus unit, and
wherein preferably the optical output device comprises a carrier device that carries the bus wires and the bus units,
wherein the carrier device preferably comprises in at least 90 percent of volume a printed circuit board material, especially FR-4 or a flexible material, or a plastic material or a metal,
and wherein preferably the bus units and also the bus control unit are implemented as electronic circuit respectively, especially in ASICs, wherein the electronic circuit is preferably implemented as state machine, preferably as a state machine without a processor that executes commands of a program.

9. A bus unit, comprising:
a storage cell for storing an identifier, especially an address, that identifies the respective bus unit with regard to the other bus units on the same bus wires in an unambiguous way,
a counter unit,
a comparison unit, and
a bus access unit that accesses the bus depending on an output signal of the comparison unit.

10. The bus unit according to claim 9, wherein the bus unit comprises subunits of a bus unit in an input arrangement, preferably an 8b/10b encoding unit and/or an 8b/10b decoding unit.

11. A bus control unit, comprising:
a state machine,
an interface unit to an external processor unit,
an input data memory that is used for data transmission from the processor unit to the bus control unit, and
an output data memory that is used for data transmission from the bus control unit to the processor unit.

12. The bus control unit according to claim 11, wherein the bus control unit comprises subunits of a bus unit in an input arrangement:
a storage cell for storing an identifier, especially an address, that identifies the respective bus control unit with regard to other bus control units on the same bus wires in an unambiguous way,
a counter unit,
a comparison unit, and
a bus access unit that accesses the bus depending on an output signal of the comparison unit.

13. A method for operating an input arrangement comprising:
using at least two bus wires of a bus,
connecting a plurality of bus units in parallel connection to the bus wires,
using at least one bus control unit that receives data from the bus units depending on pressed input elements (S1) that are electrically connected to the bus units.

14. The method according to claim 13, comprising:
allocation of internal identifiers to bus units,
at least during block read or block write operations all bus units or at least two bus units read data on the bus wires,
at least during block read or block write operations all bus units or at least two bus units count an internal counter up or down,
at least during block read or block write operations all bus units or at least two bus units compare their internal identifier and the value of the internal counter,
at least during block read or block write operations the bus is accessed, preferably for reading or writing of data, by the bus units depending on the result of the comparison, especially if the result of the comparison is positive.

15. A method for the assembling of an input arrangement comprising
using at least two bus wires of a bus,
connecting a plurality of bus units in parallel connection to the bus wires,
connecting to the bus wires at least one bus control unit that receives data from the bus units depending on pressed input elements that are electrically connected to the bus units.
